(19) United States
(12) Patent Application Publication
(10) Pub. No.: US 2019/0329557 A1
(43) Pub. Date: Oct. 31, 2019

(54) INKJET PRINTING DEVICE

(71) Applicant: MIMAKI ENGINEERING CO., LTD., Nagano (JP)

(72) Inventor: Hiroshi Kobayashi, Nagano (JP)

(73) Assignee: MIMAKI ENGINEERING CO., LTD., Nagano (JP)

(21) Appl. No.: 16/392,608

(22) Filed: Apr. 23, 2019

(30) Foreign Application Priority Data
Apr. 27, 2018 (JP) 2018-087845

(51) Int. Cl. B41J 2/165

(52) U.S. Cl. CPC B41J 2/16544

(57) ABSTRACT

An inkjet printing device includes a head having a nozzle surface in which nozzle holes are formed on a surface facing a print medium; a head holding member that holds the head; and a wiping member having a predetermined width for wiping the nozzle surface. The head holding member includes a protruding portion projecting out from the surface. The protruding portion is provided adjacent to the head on a downstream side in a wiping direction of the nozzle surface. The protruding portion has a length of greater than or equal to ½ of a width of the wiping member in a direction intersecting the wiping direction. The width of the protruding portion in a direction orthogonal to the wiping direction becomes narrower with separation away from the nozzle surface in the wiping direction. The protruding portion has a height in a projecting direction making contact with the wiping member.

### CROSS REFERENCE TO RELATED APPLICATIONS

This application claims the priority benefit of Japanese Patent Application No. 2018-087845 filed on Apr. 27, 2018. The entirety of the above-mentioned patent application is hereby incorporated by reference herein and made a part of this specification.

### TECHNICAL FIELD

The present disclosure relates to an inkjet printing device.

### DESCRIPTION OF THE BACKGROUND ART

An inkjet printing device includes a wiping mechanism that wipes (scrapes off) the ink attached to a nozzle surface. Japanese Unexamined Patent Publication No. 2002-67345 discloses an inkjet printing device in which an outer peripheral edge of a nozzle surface is curved so as not to cause ink remaining unwiped.

FIG. 8A and FIG. 8B are views describing an inkjet printing device 100 according to a conventional example. FIG. 8A is a view of a nozzle surface 310 viewed from a print medium side. FIG. 8B is a cross-sectional view taken along line A-A in FIG. 8A, and is a view in which the nozzle surface 310 directed toward the lower side. As shown in FIG. 8A, a head 31 of the inkjet printing device 100 according to the conventional example is mounted on a carriage 300 and is movable in a main scanning direction X (axis line direction). The head 31 has a nozzle surface 310 on which a plurality of nozzle holes 315 that eject ink are formed. The head 31 is disposed such that the nozzle surface 310 faces a print medium (not shown), and ejects ink droplets from the nozzle holes 315 toward the print medium.

Here, as shown in FIG. 8B, ink Q attaches to the nozzle surface 310. In order to remove the ink Q attached to the nozzle surface 310, the inkjet printing device 100 includes a wiping mechanism 6 for removing the ink Q. The wiping mechanism 6 relatively moves a wiper 600 from one side edge 311 to the other side edge 312 of the nozzle surface 310 in the main scanning direction X to scrape off the ink Q attached to the nozzle surface 310 (see arrow in the figure). The wiper 600 is a plate-shaped elastic member.

Upon scraping off the ink Q, the wiper 600 elastically deforms in a state in which a distal end 601 side sliding on the nozzle surface 310 is inclined toward the back side in the moving direction than a basal end 602 side. The strain energy of the wiper 600 due to the elastic deformation is released at the moment when the distal end 601 of the wiper 600 separates from the other side edge 312 of the nozzle surface 310. As a result, the ink Q scraped off by the wiper 600 is flicked away.

For example, when a plurality of heads 31 are juxtaposed on a carriage 300 in the main scanning direction X, ink flicked away from one head 31 hits the nozzle surface 310 of the adjacent head 31 and causes adverse effects. In order to avoid this, the adjacent heads 31 need to be spaced apart by a predetermined length. Therefore, the carriage 300 enlarges.

Therefore, it is desired to suppress the flicking away of the scraped ink.

### SUMMARY

The present disclosure relates to an inkjet printing device including a head having a nozzle surface in which a plurality of nozzle holes are formed on a surface facing a print medium; a head holding member that holds the head; and a wiping member having a predetermined width for wiping the nozzle surface; where the head holding member includes a protruding portion projecting out from a surface facing the print medium, the protruding portion being provided adjacent to the head on a downstream side of the head in a wiping direction of the nozzle surface by the wiping member, and the protruding portion having a length of greater than or equal to ½ of a width of the wiping member in a direction intersecting the wiping direction; the width of the protruding portion in a direction orthogonal to the wiping direction becomes narrower with separation away from the nozzle surface in the wiping direction; and the protruding portion has a height in a projecting direction making contact with the wiping member.

In the inkjet printing device according to one aspect of the present disclosure, a length of the protruding portion in the wiping direction becomes shorter from one side to the other side in a direction orthogonal to the wiping direction.

In the inkjet printing device according to one aspect of the present disclosure, the protruding portion has an inclined surface that approaches the head holding member with separation away from the nozzle surface in the wiping direction.

In the inkjet printing device according to one aspect of the present disclosure, the wiping member is a plate-shaped elastic body; a distal end side in a direction intersecting the nozzle surface is brought into contact with the nozzle surface, and a basal end side in the direction intersecting the nozzle surface is supported by a support member; and the distal end side is provided with a rake face having a curved shape on a front side in the wiping direction.

In the inkjet printing device according to one aspect of the present disclosure, the plurality of nozzle holes are linearly disposed in a direction orthogonal to the wiping direction to constitute a nozzle row; and the wiping member is disposed with a longitudinal direction of the wiping member along a straight line parallel to the nozzle row.

According to the present disclosure, the flicking away of the scraped ink can be suppressed.

### BRIEF DESCRIPTION OF THE DRAWINGS

FIG. 1 is a view describing an inkjet printing device.

FIG. 2 is an enlarged view of a main part of the inkjet printing device.

FIG. 3A to FIG. 3C are views describing a carriage of the inkjet printing device.

FIG. 4A to FIG. 4C are views describing a wiping mechanism.

FIG. 5A to FIG. 5C are views describing a wiper.

FIG. 6 is a view describing scraping of ink by the wiping mechanism.

FIG. 7A to FIG. 7F are views describing scraping of ink by the wiping mechanism.

FIG. 8A and FIG. 8B are views describing an inkjet printing device according to a conventional example.

### DESCRIPTION OF EMBODIMENTS

Hereinafter, an embodiment according to the present disclosure will be described by taking an inkjet printing device 1 equipped with a wiping mechanism 6 as an example.

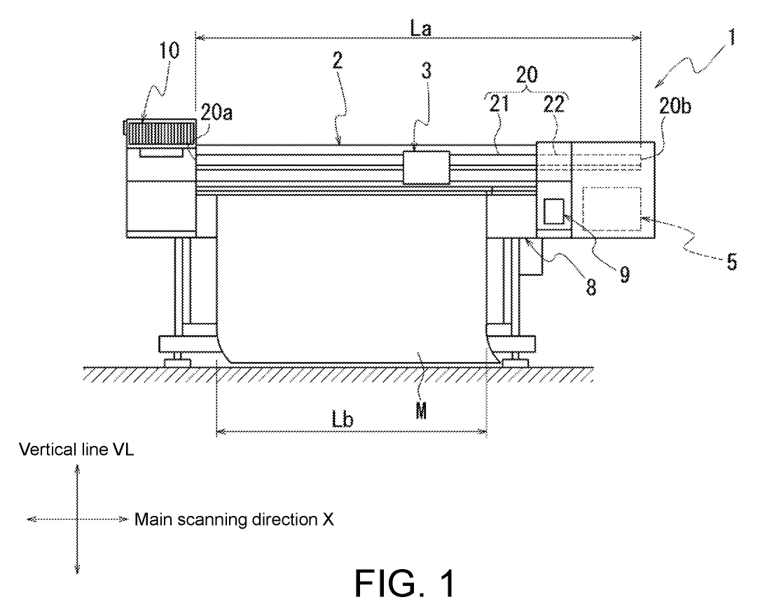

FIG. 1 is a schematic view describing an inkjet printing device 1. In FIG. 1, description of a front cover is omitted. Furthermore, a part of a guide rail 20 is described with a virtual line.

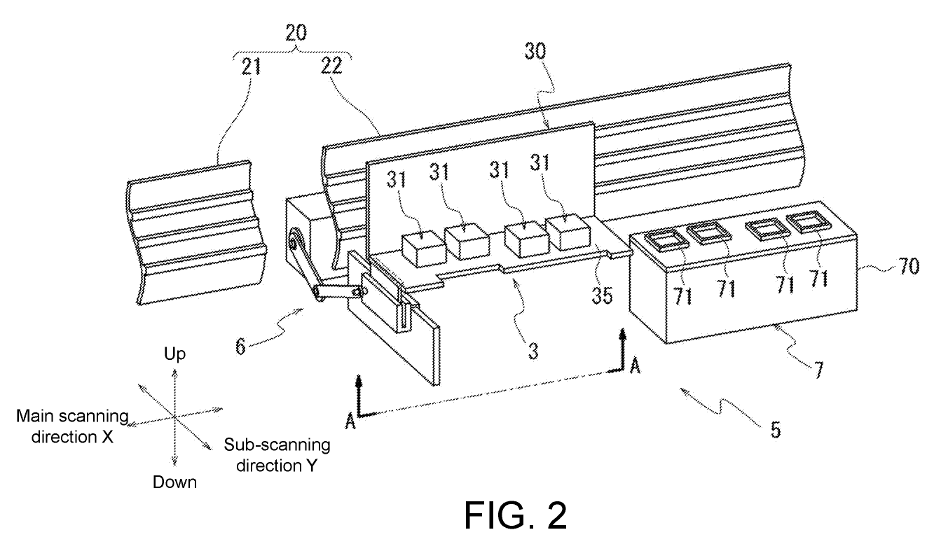

FIG. 2 is an enlarged view of a main part of the inkjet printing device 1, and is a view describing a state where a printing unit 3 is disposed at a standby position. For the sake of convenience of explanation, in FIG. 2, a part of the guide rail 20 is shown cut out, and the position of a suction device 37 is shown shifted. In the following description, a vertical line VL direction with an installation state of the inkjet printing device 1 as a reference is also indicated as the vertical direction.

As shown in FIG. 1, the inkjet printing device 1 includes a housing 2, a printing unit 3 for forming (printing) an image on a print medium M, an ink tank 10 for storing ink, a maintenance unit 5 for performing maintenance, and a conveying unit 8 for conveying the print medium M. The print medium M is, for example, paper or cloth, resin sheet made of vinyl chloride, polyester, or the like.

The number of the ink tanks 10 is set according to the type of ink to be used. The ink stored in the ink tank 10 is supplied to a head 31 of the printing unit 3 to be described later by an ink supplying device (not shown). The conveying unit 8 conveys the print medium M in a sub-scanning direction Y.

The inkjet printing device 1 includes an operation panel 9 disposed in the housing 2 and a control device (not shown). The control device is electrically connected to the printing unit 3, the conveying unit 8, and other components of the inkjet printing device 1. The control device controls the operation of each component of the inkjet printing device 1 in accordance with an input signal from the operation panel 9. A printing process and an ink discharging process on the print medium M, a maintenance process of the printing unit 3 to be described later, and the like are executed. Specifically, the control device is a microcomputer, and includes a CPU, a RAM, a ROM, an input port, and an output port.

As shown in FIG. 2, the printing unit 3 is disposed in the housing 2. The printing unit 3 includes a head 31 that ejects ink droplets toward the print medium M, and a carriage 30 that holds the head 31. In the embodiment, the carriage 30 holds four heads 31. The four heads 31 are juxtaposed on the carriage 30 along the main scanning direction X.

The carriage 30 of the printing unit 3 is engaged with a guide rail 20 provided in the housing 2. The guide rail 20 is provided with its longitudinal direction along the main scanning direction X. The carriage 30 can reciprocate in the main scanning direction X by way of the guide rail 20. The carriage 30 is moved using a carriage moving device (not shown).

Here, the guide rail 20 is disposed above the print medium M. In the main scanning direction X, the length La of the guide rail 20 is longer than the length Lb of the print medium M (La>Lb). In this case, one end 20a side in the longitudinal direction of the guide rail 20 vertically faces the print medium M, and the other end 20b side vertically faces the maintenance unit 5 to be described later.

The guide rail 20 is configured by a first guide portion 21 that faces the print medium M on the one end 20a side and a second guide portion 22 that faces the maintenance unit 5 on the other end 20b side. When performing printing, the printing unit 3 is moved on the first guide portion 21 and ejects ink droplets onto the print medium M. When not performing printing, the printing unit 3 stands by at a predetermined position on the second guide portion 22 (this position will be hereinafter referred to as a standby position). In the printing unit 3, the maintenance of the head 31 is performed by the maintenance unit 5 at the standby position on the second guide portion 22.

### Maintenance Unit 5

As shown in FIG. 2, the maintenance unit 5 of the inkjet printing device 1 is provided on the other end 20b side (right side in FIG. 1) of the guide rail 20 in the main scanning direction X. The maintenance unit 5 includes a wiping mechanism 6 that wipes the nozzle surface 310 of the head 31 to be described later, and a suction device 7 that suctions ink in the head 31.

### Wiping Mechanism 6

The wiping mechanism 6 is disposed below the second guide portion 22. The wiping mechanism 6 is disposed closer to the first guide portion 21 side in the main scanning direction X than the standby position of the printing unit 3. The wiping mechanism 6 scrapes off the ink Q attached to the nozzle surface 310 of the head 31. Details will be described later.

### Suction Device 7

The suction device 7 is disposed below the second guide portion 22. The suction device 7 is located below the printing unit 3 at the standby position of the printing unit 3. The suction device 7 includes a main body unit 70, caps 71 as many as the heads 31, an ink discharge pipe (not shown), and a suction pump (not shown).

The suction device 7 according to the embodiment includes four caps 71 in correspondence with the four heads 31. Each cap 71 is held by a main body unit 70. When the printing unit 3 is at the standby position, the cap 71 faces the nozzle surface 310 of the head 31. The main body unit 70 is movable in the vertical direction. When the main body part 70 is moved toward the upper side, the cap 71 covers the nozzle surface 310 of the head 31.

Thus, the suction device 7 generates a negative pressure in a space formed between the cap 71 and the nozzle surface 310, and suctions the ink remaining in the nozzle of the head 31 (not shown). The ink discharge pipe (not shown) discharges the ink suctioned by the suction pump to a waste ink tank (not shown).

The maintenance of the head 31 by the maintenance unit 5 is performed in the following procedure. (i) The ink Q remaining in the nozzle of the head 31 is suctioned by the suction device 7. (ii) The ink Q bulges out from the nozzle surface 310 due to the suction. The ink Q having bulged out (attached) from the nozzle surface 310 is scraped off with the wiping mechanism 6. (iii) After the bulged out ink Q is scraped off, the ink droplet is slightly ejected to flush the nozzle.

### Carriage

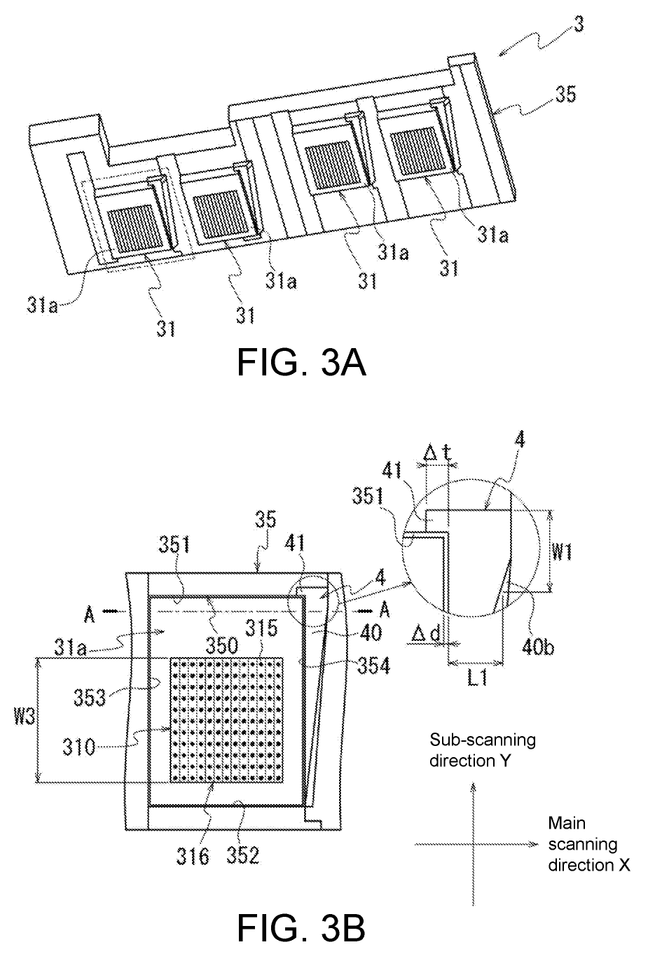

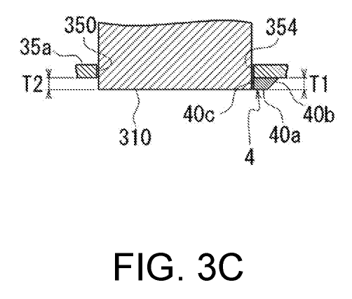

FIG. 3A to FIG. 3C are schematic views describing the carriage 30. FIG. 3A is a perspective view of the carriage 30 as seen from a direction of arrow A-A in FIG. 2. FIG. 3B is an enlarged view of region A in FIG. 3A. FIG. 3C is a sectional view taken along line B-B in FIG. 3B, and shows a state in which a lower end 31a of the head 31 is directed toward the lower side.

As shown in FIG. 2 and FIG. 3A, the head 31 is a columnar member having a rectangular shape when viewed from the vertical direction. The head 31 is provided on the carriage 30 with its longitudinal direction along the vertical direction. In the embodiment, the four heads 31 are each held by a head holding unit 35 of the carriage 30 at the lower end 31a side in the vertical direction. In the following description, one head 31 will be described by way of an example.

As shown in FIG. 3B, the lower end 31a of the head 31 has a nozzle surface 310 formed with a plurality of nozzle holes 315 for ejecting ink droplets. The nozzle surface 310 is a flat surface orthogonal to the vertical line VL. The plurality of nozzle holes 315 form a nozzle row 316 linearly lined along the sub-scanning direction Y. A plurality of nozzle rows 316 are provided on the nozzle surface 310 along the main scanning direction X. The ink droplets of a different color are ejected for every nozzle row 316.

An opening 350 having a shape corresponding to the head 31 is opened in the head holding unit 35 of the carriage 30. The head 31 is held by the carriage 30 by inserting the lower end 31a side of the head 31 into the opening 350. The nozzle surface 310 projects out more downward in the vertical direction than a bottom surface 35a of the head holding unit 35. The projecting height of the nozzle surface 310 from the bottom surface 35a is T2.

The opening 350 includes a pair of side edges 351 and 352 disposed in parallel in the main scanning direction X and a pair of mutually parallel side edges 353 and 354 that connects the ends of the side edges 351 and 352. The opening 350 has a rectangular shape when viewed from the vertical direction. The pair of side edges 351 and 352 is provided along the sub-scanning direction Y. The pair of side edges 353 and 354 is provided along the main scanning direction X.

### Protruding Portion

A protruding portion 4 is provided on the side edge 354 of the opening 350 on the bottom surface 35a of the head holding unit 35. The protruding portion 4 projects out downward from the bottom surface 35a and is integrally formed with the carriage 30 (see FIG. 3C).

The protruding portion 4 includes a base portion 40 extending over the entire length of the side edge 354 in the sub-scanning direction Y and an extending portion 41 extending in the main scanning direction X from one end in the sub-scanning direction Y of the base portion 40. The extending portion 41 is provided on the side edge 351 in the sub-scanning direction Y. The extending portion 41 extends on the side edge 351 in the main scanning direction X direction. An extending length Δt of the extending portion 41 in the main scanning direction X is longer than a length Δd of a gap between the opening 350 and the head 31 (Δt>Δd). It should be noted that the base portion 40 may not extend over the entire length of the side edge 354 in the sub-scanning direction Y. It merely needs to be at least a length longer than or equal to ½ of the width W2 of the wiper blade 61 to be described later.

As shown in FIG. 3B, the base portion 40 is such that the width W1 in the sub-scanning direction Y becomes narrower the farther away from the nozzle surface 310 in the main scanning direction X. The length L1 in the main scanning direction X of the base portion 40 becomes shorter from the side edge 351 toward the side edge 352 in the sub-scanning direction Y. That is, the base portion 40 has a substantially right triangular shape when viewed from the vertical direction.

As shown in FIG. 3C, the projecting height T1 from the bottom surface 35a of the base portion 40 and the extending portion 41 is slightly lower than the projecting height T2 from the bottom surface 35a of the nozzle surface 310 (T1<T2). The distal end face 40a of the base portion 40 in the vertical direction is parallel to the nozzle surface 310. The distal end face 41a of the extending portion 41 in the vertical direction is flush with the distal end face 40a of the base portion 40 (not shown).

The side surface on the side opposite to the opening 350 of the base portion 40 in the main scanning direction X is an inclined surface 40b inclined in a direction of separating away from the opening 350 from the distal end face 40a of the base portion 40 toward the bottom surface 35a in the vertical direction. The side surface 40c of the base portion 40 on the opening 350 side in the main scanning direction X is flush with the side edge 354 of the opening 350 in the vertical direction.

### Wiping Mechanism 6

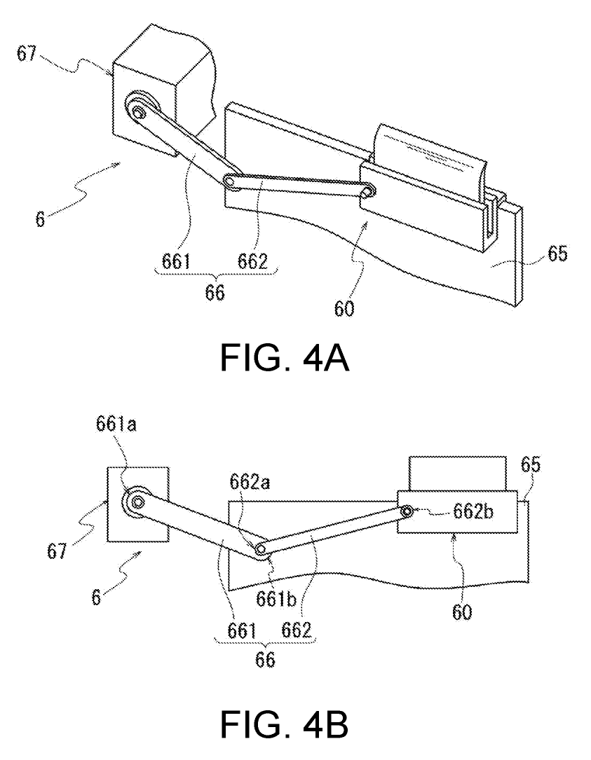

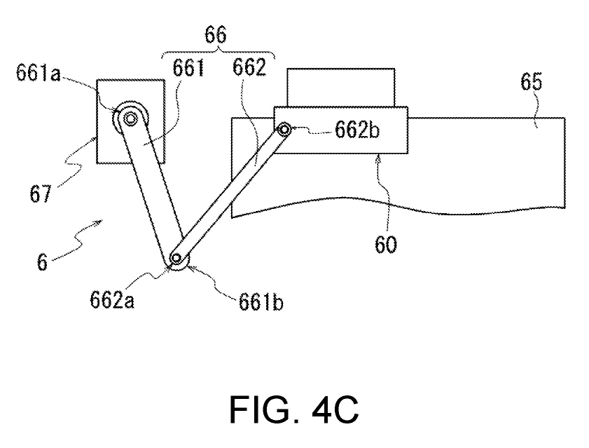

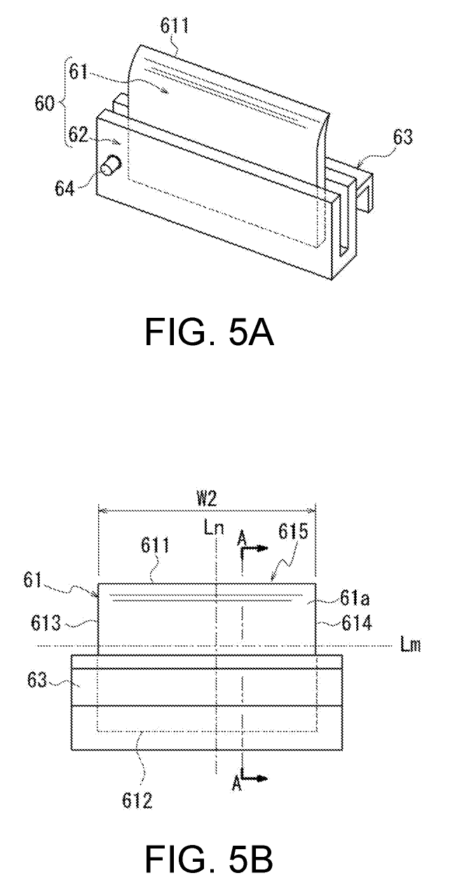

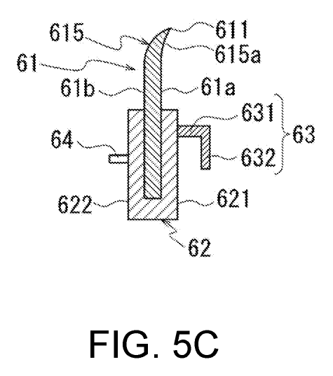

The wiping mechanism 6 will be described with reference to FIG. 4A to FIG. 5C. FIG. 4A to FIG. 4C are views describing the wiping mechanism 6. FIG. 4A is a perspective view of the wiping mechanism 6, is a view showing only the wiping mechanism 6 in FIG. 2, and is a view showing a state in which a link mechanism unit 66 is developed. FIG. 4B is a view showing the wiping mechanism 6 as seen from the direction of arrow A-A in FIG. 4A. FIG. 4C is a view showing a state in which the link mechanism unit 66 is folded.

As shown in FIG. 4A, the wiping mechanism 6 includes a wiper unit 60, a guide rail 65 for guiding the movement of the wiper unit 60, a driving unit 67 for generating a driving force for moving the wiper unit 60, and a link mechanism unit 66 for transmitting the driving force to the wiper unit 60. The wiping mechanism 6 may further include a cleaning mechanism for wiping the ink Q attached to the wiper unit 60.

As shown in FIG. 2, the guide rail 65 of the wiping mechanism 6 is provided under the guide rail 20 of the housing 2 along a direction orthogonal to the guide rail 20 (sub-scanning direction Y). The wiper unit 60 is engaged with the guide rail 65.

### Link Mechanism

As shown in FIG. 4B, the wiper unit 60 is coupled to the driving unit 67 through the link mechanism unit 66. The link mechanism unit 66 includes a first link member 661 and a second link member 662 which are formed in a long flat plate shape.

The first link member 661 is connected to the driving unit 67 so as to transmit power at one end 661a in the longitudinal direction. The first link member 661 is turnably connected to the second link member 662 at the other end 661b in the longitudinal direction.

The second link member 662 is turnably connected to the other end 661b of the first link member 661 at one end 662a in the longitudinal direction. The second link member 662 is swingably connected to the wiper unit 60 at the other end 662b in the longitudinal direction.

The link mechanism unit 66 is capable of being developed (extended) or folded (contracted) by swinging the first link member 661 and the second link member 662. The wiper unit 60 can move forward and backward along the guide rail 65 by developing or folding the link mechanism unit 66 (see FIG. 4B and FIG. 4C).

The driving unit 67 is configured by a motor, a pulley, a gear, and the like (not shown). The rotational driving force of the motor is transmitted to the first link member 661 via a pulley, a gear, or the like. As a result, the first link member 661 swings about the one end 661a.

### Wiper Unit

FIG. 5A to FIG. 5C are views describing the wiper unit 60. FIG. 5A is a perspective view of the wiper unit 60. FIG. 5B is a plan view of the wiper unit 60. FIG. 5C is a cross-sectional view taken along line A-A of the wiper unit 60 in FIG. 5B.

As shown in FIG. 5A, the wiper unit 60 includes a plate-like wiper blade 61 and a holding portion 62 that holds the wiper blade 61. The wiper blade 61 is made of a resin material such as propylene or an elastic material such as EPDM.

As shown in FIG. 5A, the wiper blade 61 includes a pair of long side portions 611 and 612 disposed in parallel with each other, and a pair of short side portions 613 and 614 disposed in parallel with each other for connecting the ends of the long side portions 611 and 612. The wiper blade 61 has a substantially rectangular shape when viewed from the thickness direction. The long side portions 611 and 612 are parallel to a straight line Lm along the longitudinal direction. The short side portions 613 and 614 are parallel to a straight line Ln orthogonal to the straight line Lm.

The long side portion 612 side (lower side in the figure) in the direction of the straight line Ln of the wiper blade 61 is a fixed end fixed to the holding portion 62. The long side portion 611 side (upper side in the figure) in the direction of the straight line Ln of the wiper blade 61 is a free end. In the following description, the long side portion 612 of the wiper blade 61, which is the fixed end, is also referred to as the basal end 612. The long side portion 611 of the wiper blade 61, which is the free end, is also referred to as the distal end 611.

The width W2 of the wiper blade 61 in the sub-scanning direction Y is greater than or equal to the width W3 (see FIG. 3B) of the nozzle 310 (W2>W3). This is because the entire nozzle surface 310 can be wiped substantially uniformly by a single wiping scan in wiping the ink, although details will be described later.

As shown in FIG. 5C, a curved portion 615 curved to a circular arc shape is formed on the distal end 611 side of the wiper blade 61. Specifically, the curved portion 615 is curved toward the one surface 61a side in the thickness direction of the wiper blade 61.

The curved portion 615 is formed over the entire length of the wiper blade 61 in the direction of the straight line Lm (left and right direction in FIG. 5B). The surface on the one surface 61a side of the wiper blade 61 in the curved portion 615 is a concave shaped rake face 615a.

As shown in FIG. 5C, in the holding portion 62, one surface 621 and the other surface 622 in the thickness direction of the wiper blade 61 are flat surfaces orthogonal to the thickness direction of the wiper blade 61.

A locking portion 63 is provided on one surface 621. The locking portion 63 is configured by an arm portion 631 extending in a thickness direction of the wiper blade 61 in a direction away from the one surface 621 and a locking piece 632 extending toward the lower side from the distal end of the arm portion 631. A protrusion 64 is provided on the other surface 622. The protrusion 64 extends in a thickness direction of the wiper blade 61 in a direction away from the other surface 622.

Here, the wiper unit 60 is disposed in a state in which the thickness direction of the wiper blade 61 lies along the main scanning direction X. In this state, the wiper blade 61 is disposed in a state in which the straight line Lm along the longitudinal direction lies along the sub-scanning direction Y, and is disposed in a state in which the straight line Ln orthogonal to the longitudinal direction lies along the vertical direction (see FIG. 2). The rake face 615a of the curved portion 615 of the wiper blade 61 is disposed to face the head 31 in the main scanning direction X.

The locking portion 63 of the holding portion 62 is provided over the entire length in the sub-scanning direction Y. The locking portion 63 is engaged with the guide rail 65. The protrusion 64 of the holding portion 62 is provided on the side of the driving unit 67 in the sub-scanning direction Y. The protrusion 64 is engaged with the other end 662b of the second link member 662. That is, the wiper unit 60 is locked with the guide rail 65 on one side in the main scanning direction X, and is coupled to the driving unit 67 through the link mechanism unit 66 on the other side.

### Operation of Wiping Mechanism

In the wiping mechanism 6, the link mechanism unit 66 is developed or folded in conjunction with the rotational driving of the motor of the driving unit 67. In conjunction therewith, the wiper unit 60 moves forward and backward on the guide rail 65 in the sub-scanning direction Y (see FIG. 4B and FIG. 4C).

When scraping off the ink Q, the link mechanism unit 66 is developed. Then, the wiper unit 60 is positioned on one side in the sub-scanning direction Y (see FIG. 4B). As a result, the rake face 615a of the wiper blade 61 intersects the movement path of the nozzle surface 310 in the main scanning direction X.

When not scraping off the ink Q, the link mechanism unit 66 is folded. The wiper unit 60 is positioned on the other side (the far side in the figure) in the sub-scanning direction Y (see FIG. 4C). The rake face 615a of the wiper blade 61 is at a position away (retracted) from the movement path of the nozzle surface 310.

### Ink Scraping

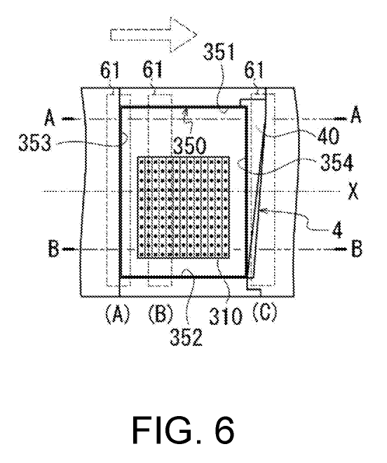

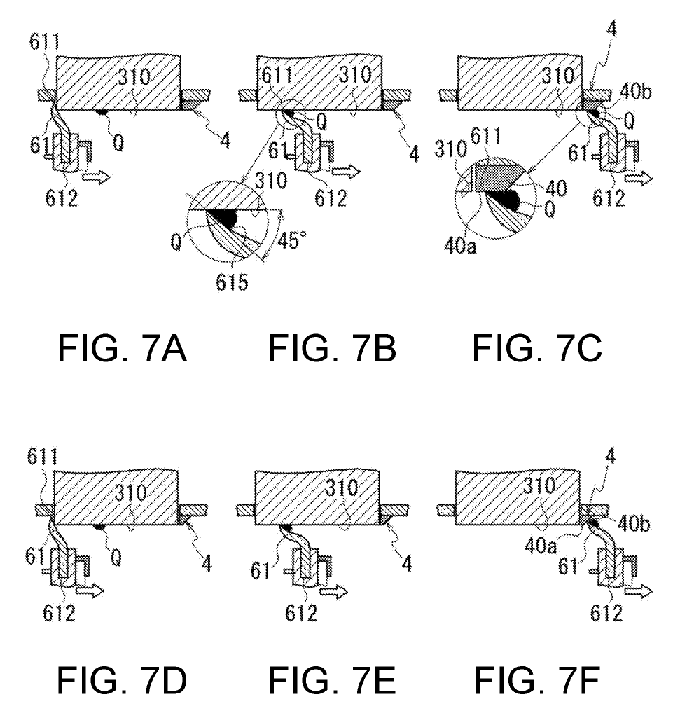

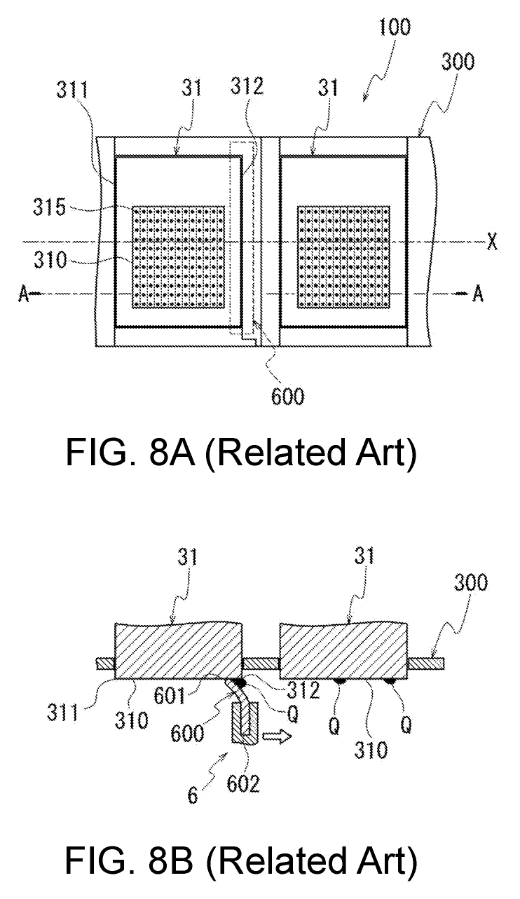

The scraping of the ink Q of the wiping mechanism 6 will be described. FIG. 6 and FIG. 7A to FIG. 7F are views describing the scraping of the ink Q by the wiping mechanism 6. In FIG. 6, a case where the wiper blade 61 is at the positions (A), (B), and (C) with respect to the nozzle surface 310 is shown. The wiper blade 61 is shown with a virtual line. FIG. 7A is a view showing a cross section taken along line A-A in FIG. 6, and shows a case where the wiper blade 61 is at position (A). FIG. 7B is a view showing a cross section taken along line A-A in FIG. 6, and shows a case where the wiper blade 61 is at position (B). FIG. 7C is a view showing a cross section taken along line A-A in FIG. 6, and shows a case where the wiper blade 61 is at position (C). FIG. 7D is a view showing a cross section taken along line B-B in FIG. 6, and shows a case where the wiper blade 61 is at position (A). FIG. 7E is a view showing a cross section taken along line B-B in FIG. 6, and shows a case where the wiper blade 61 is at position (B). FIG. 7F is a view showing a cross section taken along line B-B in FIG. 6, and shows a case where the wiper blade 61 is at position (C).

The wiping mechanism 6 is disposed below the printing unit 3 (carriage 30) (see FIG. 2). Specifically, the wiping mechanism 6 is disposed at a position where the distal end 611 of the wiper blade 61 is brought into contact with the nozzle surface 310 of the head 31 (see FIG. 7A to FIG. 7F).

When scraping off the ink Q, the link mechanism unit 66 is developed. The rake face 615a of the wiper blade 61 intersects the movement path of the nozzle surface 310.

The printing unit 3 is moved in this state by a predetermined distance toward the first guide portion 21 side (leftward in FIG. 2). Then, the nozzle surface 310 slides on the wiper blade 61. The ink Q attached to the nozzle surface 310 is thereby scraped off.

As shown in FIG. 6, when viewed from the nozzle surface 310, the wiper blade 61 relatively moves from the side edge 353 side to the side edge 354 side of the opening 350 in the main scanning direction X (see the broken line arrow in the figure). In the following description, the moving direction of the wiper blade 61 as viewed from the nozzle surface 310 will be described with the side edge 353 side of the opening 350 taken as the upstream side and the side edge 354 side as the downstream side.

As shown in FIG. 7A and FIG. 7D, the distal end 611 of the wiper blade 61 is first brought into contact with the nozzle surface 310 while approaching. Therefore, the distal end 611 side of the wiper blade 61 is inclined more toward the back side in the advancing direction in the main scanning direction X than a basal end 612 side. Thus, the wiper blade 61 elastically deforms in a state inclined with respect to the nozzle surface 310. As a result, the strain energy accumulates in the wiper blade 61.

As shown in FIG. 7B and FIG. 7E, when the wiper unit 60 is further moved to the downstream side, the wiper blade 61 slides on the nozzle surface 310 while elastically deforming. The wiper blade 61 scrapes off the ink Q attached to the nozzle surface 310 by such sliding.

Specifically, the wiper blade 61 is elastically deformed and is inclined by about 45 degrees with respect to the nozzle surface 310. Thus, the rake face 615a of the wiper blade 61 faces the nozzle surface 310. The ink Q attached to the nozzle surface 310 is scraped off in such a way that it is scooped up by the rake face 615a.

As described above, the width W2 of the wiper blade 61 is larger than the width W3 of one nozzle surface 310. Therefore, the ink Q on the nozzle surface 310 of one head 31 can be scraped with one movement in the main scanning direction X of the wiper blade 61.

As shown in FIG. 7C and FIG. 7F, the protruding portion 4 is provided on the downstream side in the moving direction of the wiper unit 60. Therefore, after finished with scraping off the ink Q at the nozzle surface 310, the wiper blade 61 rides onto the protruding portion 4. Although there is a slight gap of a length Δd in the main scanning direction X between the head 31 and the opening 350, the wiper blade 61 rides onto the extending portion 41 of the protruding portion 4 before passing through the gap. This is because the extending length Δt of the extending portion 41 is longer than the length Δd of the gap (Δt>Δd, see FIG. 3B), as described above. Thus, the wiper blade 61 is prevented from being caught in the gap between the head 31 and the opening 350.

The base portion 40 of the protruding portion 4 has a substantially right triangular shape when viewed from the vertical direction (see FIG. 6). When the wiper blade 61 rides on the base portion 40, the distal end 611 of the wiper blade 61 slides on the distal end face 40a of the base portion 40.

When the wiper blade 61 further moves in the main scanning direction X while riding on the base portion 40, the distal end 611 no longer slides on the distal end face 40a of the base portion 40 at the side edge 352 side (lower side in FIG. 6) of the opening 350 in the sub-scanning direction Y (see FIG. 7F). That is, elastic deformation is canceled. In this case, the side edge 351 side (upper side in FIG. 6) of the opening 350 in the sub-scanning direction Y slides on the distal end face 40a of the base portion 40 (see FIG. 7C). That is, it is elastically deformed.

Therefore, the strain energy on the side edge 352 side (lower side in FIG. 6) of the opening 350 in the sub-scanning direction Y is released first. As the wiper blade 61 moves in the main scanning direction X, the wiper blade 61 sequentially releases the strain energy from the other side (side edge 352 of opening 350) side to one side (side edge 351 of opening 350) side in the sub-scanning direction Y. Therefore, strain energy can be gradually released. The flicking away of the scraped ink Q thus can be more suitably suppressed. As a result, the wiper blade 61 prevents the strain energy from being released all at once over the entire length in the sub-scanning direction Y. Therefore, the ink Q can be prevented from being applied to the nozzle surface 310 of the adjacent head 31 without increasing the interval between the adjacent heads 31.

Here, the protruding portion 4 includes an inclined surface 40b (see FIG. 3C). When releasing the strain energy, the wiper blade 61 slides on the inclined surface 40b (see FIG. 7F). Then, the strain energy to be released is reduced by the friction when the wiper blade 61 slides on the inclined surface 40b. Therefore, the ink Q can be more suitably prevented from being applied to the nozzle surface 310 of the adjacent head 31 without increasing the interval between the adjacent heads 31.

When the wiper blade 61 is further moved, the wiper blade 61 separates from the protruding portion 4. The scraping of the ink Q with respect to one head 31 is thereby terminated.

Similarly, the scraping of the ink Q is carried out with respect to the remaining heads 31. After the scraping with respect to all the heads 31 is terminated, the link mechanism unit 66 is folded. Then, the wiper unit 60 is positioned on the other side in the sub-scanning direction Y. The rake face 615a of the wiper blade 61 is thereby separated (retracted) from the movement path of the nozzle surface 310.

As described above, the inkjet printing device 1 of the present embodiment has the following configuration. (1) The inkjet printing device 1 includes a head 31 having a nozzle surface 310 in which a plurality of nozzle holes 315 are formed on a surface facing a print medium M, a carriage 30 (head holding member) for holding the head 31, and a wiper blade 61 (wiping member) having a predetermined width W2 for wiping the nozzle surface 310. The carriage 30 includes a protruding portion 4 that projects out from a surface (bottom surface 35a) facing the print medium M. The protruding portion 4 is provided adjacent to the nozzle surface 310 on the downstream side of the head 31 in the wiping direction of the nozzle surface 310 by the wiper blade 61. The protruding portion 4 has a length greater than or equal to ½ of the width W2 of the wiper blade 61 in the sub-scanning direction Y intersecting the wiping direction (main scanning direction X). The width W1 in the sub-scanning direction Y of the protruding portion 4 becomes narrower as it separates away from the nozzle surface 310 in the main scanning direction X. The protruding portion 4 has a height T1 in the projecting direction that makes contact with the wiper blade 61.

According to such a configuration, the strain energy of the wiper blade 61 due to the elastic deformation is gradually released from a portion away from the protruding portion 4. Therefore, the flicking away of the scraped ink Q can be suppressed. In the embodiment, the wiper blade 61 performs wiping along the main scanning direction X, but this is not the sole case. For example, the wiper blade 61 may perform wiping along the sub-scanning direction Y. Even in this case, the width W2 of the wiper blade 61 is set to a width so that the entire nozzle surface 310 can be wiped substantially uniformly by a single wiping scan.

(2) The length L1 in the main scanning direction X of the protruding portion 4 becomes shorter from one side (side edge 351 of opening 350) toward the other side (side edge 352 of opening 350) in the sub-scanning direction Y.

According to such a configuration, the strain energy of the wiper blade 61 due to the elastic deformation is released sequentially from the other side (side edge 352 of opening 350) toward the one side (side edge 351 of opening 350) in the sub-scanning direction Y. Therefore, the strain energy can be gradually released and the flicking away of the scraped ink Q can be more suitably suppressed.

(3) The protruding portion 4 includes an inclined surface 40b that approaches the carriage 30 as it separates from the nozzle surface 310 in the main scanning direction X.

According to such a configuration, the wiper blade 61 slides on the inclined surface 40b as it separates from the protruding portion 4. The strain energy of the wiper blade 61 due to the elastic deformation is thus released while receiving the sliding resistance. Therefore, the flicking away of the scraped ink Q can be more suitably suppressed.

(4) The wiper blade 61 is a plate-shaped elastic body. In the wiper blade 61, the distal end 611 side in the direction orthogonal to (intersecting) the nozzle surface 310 makes contact with the nozzle surface 310. In the wiper blade 61, the basal end 612 side in a direction orthogonal to (intersecting) the nozzle surface 310 is supported by the holding portion 62 (supporting portion) that supports the wiper blade 61. On the distal end 611 side, a curved rake face 615a is provided on the front side in the wiping direction (main scanning direction X).

According to such a configuration, the ink Q attached to the nozzle surface 310 can be reliably scraped off with the wiper blade 61.

(5) The plurality of nozzle holes 315 are linearly disposed in the sub-scanning direction Y to constitute the nozzle row 316. The wiper blade 61 is disposed so that the straight line Lm along the longitudinal direction of the wiper blade 61 lies along the sub-scanning direction Y. The straight line Lm is parallel to the nozzle row 316.

According to such a configuration, the wiper blade 61 passes through the nozzle row 316 in the shortest time, and thus the time required for scraping off the ink Q can be shortened.

The present disclosure is not limited to the mode of the above-described embodiment, and can be appropriately changed within the scope of the technical idea of the present disclosure of the present application.

What is claimed is:

1. An inkjet printing device, comprising:
a head, having a nozzle surface in which a plurality of nozzle holes are formed on a surface facing a print medium;
a head holding member that holds the head; and
a wiping member, having a predetermined width for wiping the nozzle surface,
wherein
the head holding member comprises: a protruding portion, projecting out from the surface facing the print medium,
the protruding portion being provided adjacent to the head on a downstream side of the head in a wiping direction of the nozzle surface by the wiping member, and
the protruding portion having a length of greater than or equal to ½ of a width of the wiping member in a direction intersecting the wiping direction,
the width of the protruding portion in a direction orthogonal to the wiping direction becomes narrower with separation away from the nozzle surface in the wiping direction, and
the protruding portion has a height in a projecting direction making contact with the wiping member.

2. The inkjet printing device according to claim 1, wherein
a length of the protruding portion in the wiping direction becomes shorter from one side to the other side in a direction orthogonal to the wiping direction.

3. The inkjet printing device according to claim 1, wherein
the protruding portion has an inclined surface that approaches the head holding member with separation away from the nozzle surface in the wiping direction.

4. The inkjet printing device according to claim 2, wherein
the protruding portion has an inclined surface that approaches the head holding member with separation away from the nozzle surface in the wiping direction.

5. The inkjet printing device according to claim 1, wherein
the wiping member is a plate-shaped elastic body,
a distal end side in a direction intersecting the nozzle surface is brought into contact with the nozzle surface, and a basal end side in the direction intersecting the nozzle surface is supported by a support member, and
the distal end side is provided with a rake face having a curved shape on a front side in the wiping direction.

6. The inkjet printing device according to claim 2, wherein
the wiping member is a plate-shaped elastic body,
a distal end side in a direction intersecting the nozzle surface is brought into contact with the nozzle surface, and a basal end side in the direction intersecting the nozzle surface is supported by a support member, and
the distal end side is provided with a rake face having a curved shape on a front side in the wiping direction.

7. The inkjet printing device according to claim 3, wherein
the wiping member is a plate-shaped elastic body,
a distal end side in a direction intersecting the nozzle surface is brought into contact with the nozzle surface, and a basal end side in the direction intersecting the nozzle surface is supported by a support member, and
the distal end side is provided with a rake face having a curved shape on a front side in the wiping direction.

8. The inkjet printing device according to claim 4, wherein
the wiping member is a plate-shaped elastic body,
a distal end side in a direction intersecting the nozzle surface is brought into contact with the nozzle surface, and a basal end side in the direction intersecting the nozzle surface is supported by a support member, and
the distal end side is provided with a rake face having a curved shape on a front side in the wiping direction.

9. The inkjet printing device according to claim 5, wherein
the plurality of nozzle holes are linearly disposed in a direction orthogonal to the wiping direction to constitute a nozzle row, and
the wiping member is disposed with a longitudinal direction of the wiping member along a straight line parallel to the nozzle row.

10. The inkjet printing device according to claim 6, wherein
the plurality of nozzle holes are linearly disposed in a direction orthogonal to the wiping direction to constitute a nozzle row, and
the wiping member is disposed with a longitudinal direction of the wiping member along a straight line parallel to the nozzle row.

11. The inkjet printing device according to claim 7, wherein
the plurality of nozzle holes are linearly disposed in a direction orthogonal to the wiping direction to constitute a nozzle row, and
the wiping member is disposed with a longitudinal direction of the wiping member along a straight line parallel to the nozzle row.

12. The inkjet printing device according to claim 8, wherein
the plurality of nozzle holes are linearly disposed in a direction orthogonal to the wiping direction to constitute a nozzle row, and
the wiping member is disposed with a longitudinal direction of the wiping member along a straight line parallel to the nozzle row.
